(19) United States
(12) Patent Application Publication
(10) Pub. No.: US 2019/0200527 A1
(43) Pub. Date: Jul. 4, 2019

(54) CONVEYOR CHAIN SLAT WITH BRUSH ASSEMBLY

(71) Applicant: Brian G. Robertson, Murray, KY (US)

(72) Inventor: Brian G. Robertson, Murray, KY (US)

(21) Appl. No.: 15/858,526

(22) Filed: Dec. 29, 2017

(51) Int. Cl. A01F 12/12

(52) U.S. Cl. CPC A01F 12/12

(57) ABSTRACT

A conveyor feeder assembly is provided herein, wherein the assembly may include a house chain slat having a brush assembly that provides sufficient grasp without having a damaging effect upon the crops, wherein the crop throughput is improved while reducing damage to the crop. In a combine for harvesting a crop bearing grain, a mechanism for conveying grain from a harvesting platform to a separator mechanism may include a plurality of slats secured to continuous conveyor chains coupled around a traverse drum and a sprocket drive means. Each slat may include the brush assembly, which may comprise at least one row of flexible members coupled to a brush base. The flexible members may be arranged in tufts and received in stepped openings through the brush base. The flexible members may include at least one row of straight or curved brush bristles; or at least one row of curved elongated fingers.

### BACKGROUND

In the agricultural industry, combine harvesters are used for reaping, threshing and winnowing a variety of grain crops from a field. These machines typically include a header assembly, which severs crop materials close to the ground as the combine is driven across a field. A feeder assembly moves the severed crop materials from the header assembly toward a threshing area of the combine. In operation, the combine cuts and gathers the crop standing in a field, and feeds the cut crop to a separator by means of a conveyor mechanism. This conveyor mechanism moves the severed crop materials from the header assembly towards a threshing assembly, where the rotor in combination with threshing concaves, thresh the grain. In particular, when the grain is threshed, the crop material is shaken or beaten to loose the grain from the husk, stems, pods, or cobs, such that the threshed grain is separated from crop Material Other than Grain (MOG). A separator assembly separates the threshed grain from the MOG. This grain is moved to a grain tank. The crop MOG, such as chaff, straw, vines, stems, and leaves, are then chopped and spread upon the field.

In operation, the conveyor mechanism retrieves crop material from the header where it is cut from the field, and moves it upwardly along an interior portion of the housing for the feeder assembly to the separator mechanism. In particular, the conveyor mechanism can include a plurality of continuous chains arranged in parallel that revolve around a transverse drum at the front of the feeder assembly and transverse sprocket means at the rear of the feeder assembly. Rotating generally in the direction of the length of the combine, the chains include a plurality of transverse slats connected to the chains at each end of the slat, which engage the crop, moving the crop in a rearward motion along the interior portion of the housing of the feeder assembly. Typically, the slats are metal, having blunt edges, which perform the function of taking the crop material from the header and ultimately, transporting the same through the feeder house assembly to the threshing assembly.

However, due to the abrasive serrated-like edges of the slats, as well as the hard and non-forgiving slat composition, the crop is most often damaged by the slats during its transportation through the feeder house assembly. In particular, given the speed at which the slats grab the crop material, the abrasive manner in which the slats grab the material, and the blunt hard edges of the slats, which are often made of steel, frequent damage to the crops occur. This damaged crop translates into damaged grain, which brings a yield and financial loss to the farmer. Particularly, there are several ways in which the conventional metal slat causes loss. First, the cracked and damaged grains fall out of the feeder assembly and are lost in the field, before the grains enter the combine for threshing. Second, the cracked and damaged grains are not captured by the combine during the threshing step and are passed out the back with MOG (such as chaff, straw, vines, and the like). In particular, the separator may include separation concave grates that are used to separate the grain from the MOG at the rear end of the combine. The separation concave grates have openings allowing the separated grain to fall through and be captured by the combine, while the MOG is dispersed out the back of the combine. However, due to the damage, some of the grain is mistaken for MOG and dispersed out the back of the combine with the MOG. Another reason my the conventional metal slat causes loss is that the combine may capture the cracked and damaged grain, but when this damaged grain is stored in the grain bin, these damaged grains further crumble into dust, which yields more loss. All farmers experience this type of loss. It is one of the most impactful reasons for loss suffered by the farming industry. Finally as another reason for the loss experienced within the agriculture industry, the cracked/damaged grain is typically “docked” by an inspector (or grain elevator), who receives the purchased grain and reviews it for inspection. Upon finding the cracked/damaged grain, the grain elevator docks the farmer, requiring him to sell the grain at a discounted price because of the damage.

It is within this context that the embodiments arise.

### SUMMARY

Embodiments of a conveyor feeder assembly is provided. It should be appreciated that the present embodiment can be implemented in numerous ways, such as a process, an apparatus, a system, a device, or a method. Several inventive embodiments are described below.

In some embodiments, a combine for harvesting a crop bearing grain, a mechanism for conveying grain from a harvesting platform to a separator mechanism is provided. The conveyor mechanism may include a house chain slat having a brush assembly that provides sufficient grasp without having a damaging effect upon the crops, wherein the crop throughput is improved while reducing damage to the crop. In a combine for harvesting a crop bearing grain, a mechanism for conveying grain from a harvesting platform to a separator mechanism may include a plurality of slats secured to continuous conveyor chains coupled around a traverse drum and a sprocket drive means. The brush assembly on each slat may comprise at least one row of flexible members coupled to a brush base. The flexible members may be arranged in tufts and received in stepped openings through the brush base. The flexible members may include at least one row of straight or curved brush bristles. In the alternative, the flexible members may include at least one row of curved elongated fingers or flat rectangular elongated fingers.

In some embodiments, a slat for a chain and slat conveyor for a feeder house in a harvesting machine such as a combine is provided. The slat may comprise a brush assembly coupled to a slat base to retrieve the crop from the harvesting platform without damaging the crop. The slat base may include a forward end and a rearward end, wherein the brush assembly may be coupled to either end. The slat base may also include a plurality of through-material holes at the outer ends of the base for fastening the slats to the at least two continuous conveyor chains using a fastening means. The brush assembly may include at least one row of flexible members coupled to a brush base. The flexible members may comprise a plurality of brush bristles arranged in tufts and received in stepped openings through the brush base. Alternatively, the flexible members may include at least one row of curved elongated fingers or flat rectangular fingers. The flexible members may be made of a metal or non-metal material. The slat base may comprise a U-shaped section having open ends, wherein the brush assembly couples to a middle portion or channel of the U-shaped section between the open ends. Alternatively, the slat base may comprise a L-shaped section having a horizontal portion and a vertical lip, wherein the brush assembly couples to the vertical lip of the L-shaped section and wherein the horizontal portion having the plurality of through-material holes for securing the slats to the at least two continuous conveyor chains using the securing means.

In some embodiments, a method of processing of crop material through a combine feeder house is provided; wherein, the feeder house includes a transverse mounted drum mounted on a shaft at a front thereof and one or more drive sprockets at a rear thereof with one or more chains positioned around and rotating around the transverse mounted drum and one or more drive sprockets, with one or more chain slats having a brush assembly. In one embodiment, the method may include providing crop material at an inlet of the feeder house using a harvesting platform. The method may also include gripping the crop material between a brush assembly and an interior wall of the housing for the feeder house, wherein the brush assembly, having at least one row of flexible members, couples to each of the one or more chain slats. For example, gripping the crop material may include gripping the crop material with at least one row of a plurality of brush bristles on a leading edge of each of the one or more slat, wherein the brush bristles retrieve the crop from the harvesting platform without damaging the crop. The crop material may be gripped with at least one row of a plurality of curved elongated fingers. In the alternative, at least one row of a plurality of flat rectangular fingers that curve may retrieve the crop from the harvesting platform. Further, the method may include pulling the gripped crop material along the interior wall of the housing using the brush assembly and through the feeder house. Additionally, the method may include providing the crop material to a threshing mechanism for separating the grain form the crop material other than grain using the brush mechanism. Further, the method may comprise separating the grain from the crop material other than grain, using the separator.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one so skilled in the art without departing from the spirit and scope of the described embodiments.

FIG. 1 is a side view of a combine having chain slat with brush assembly, in accordance with some embodiments.

FIG. 2 is a perspective view of a feeder assembly of a combine incorporating chain slats having the brush assembly in some embodiments.

FIG. 3A is a perspective view of one embodiment of a chain slat having a brush assembly including curved elongated fingers in accordance with some embodiments.

FIG. 3B is a perspective view of one embodiment of a chain slat having a brush assembly including flat rectangular fingers in accordance with some embodiments.

FIG. 3C is a perspective view of one embodiment of a chain slat having a brush assembly including flexible elongated cylindrical fingers in accordance with some embodiments.

FIG. 3D is a perspective view of one embodiment of a chain slat having a brush assembly including flexible panel having notches in accordance with some embodiments.

FIG. 4 is a perspective view of one embodiment of a chain slat having a brush assembly including brush bristles arranged in tufts and received in stepped openings through a brush base in accordance with some embodiments.

FIG. 5 is an exemplary flow diagram of a method for harvesting grain using the brush assembly, in accordance with some embodiments.

### DETAILED DESCRIPTION

The following embodiments describe a conveyor feeder house with chain slats, wherein, each chain slat includes a brush assembly. It can be appreciated by one skilled in the art, that the embodiments may be practiced without some or all of these specific details. In other instances, well known process operations have not been described in detail in order not to unnecessarily obscure the embodiments.

A conveyor feeder assembly is provided herein, wherein the assembly may include a chain slat having a brush assembly that provides sufficient grasp without having a damaging effect upon the crops, wherein the crop throughput is improved while reducing damage to the crop. In a combine for harvesting a crop bearing grain, a mechanism for conveying grain from a harvesting platform to a separator mechanism may include a plurality of slats secured to continuous conveyor chains coupled around a traverse drum and a sprocket drive means. In particular, a feeder house within the combine may include a forward crop inlet for receiving crop from the harvesting platform. The feeder house may also include a rear opening for transmitting crop to the separator mechanism. The brush assembly on each slat of the conveyor mechanism may include at least one row of flexible members coupled to a brush base. The flexible members may be arranged in tufts and received in stepped openings through the brush base. The flexible members may include at least one row of straight or curved brush bristles. In the alternative, the flexible members may include at least one row of curved elongated fingers.

In some embodiments, the slat may comprise a brush assembly coupled to a slat base to retrieve the crop from the harvesting platform without damaging the crop. The slat base may include a forward end and a rearward end, wherein the brush assembly may be coupled to either end. The slat base may also include a plurality of through-material holes at the outer ends of the base for securing the slats to the at least two continuous conveyor chains using a securing means. The brush assembly may include at least one row of flexible members coupled to a brush base. The flexible members may comprise a plurality of brush bristles arranged in tufts and received in stepped openings through the brush base. Alternatively, the flexible members may include at least one row of curved elongated fingers or flat rectangular fingers. The flexible members may be made of a metal or non-metal material. The slat base may comprise a U-shaped section having open ends, wherein the brush assembly couples to a middle portion of the U-shaped section between the open ends. Alternatively, the slat base may comprise a L-shaped section having a horizontal portion and a vertical lip, wherein the brush assembly couples to the vertical lip of the L-shaped section and wherein the horizontal portion having the plurality of through-material holes for securing the slats to the at least two continuous conveyor chains using the securing means.

In operation, a method of processing the crop material through the combine feeder house providing crop material at an inlet of the feeder house and gripping the crop material between a brush assembly and a housing portion of the feeder house (for example, the side, top, or bottom floor of the feeder house), wherein the brush assembly couples to each of the one or more chain slats of the conveyor mechanism. For example, the gripping step may include gripping the crop material with at least one row of a plurality of brush bristles on a leading edge of each of the one or more slat, wherein the curved brush bristles for retrieving the crop from the harvesting platform without damaging the crop. The crop material may be gripped with at least one row of a plurality of curved elongated fingers or flat rectangular fingers that curve to retrieve the crop from the harvesting platform. Further, the method may include pulling the gripped crop material along the housing portion of the feeder house, completely through the feeder house.

In some embodiments, the brush mechanism may couple to at least one metal slat. In some embodiments, the brush mechanism can be coupled to at least one non-metal slat. In some embodiments, the brush mechanism can be implemented on a chain driven feeder house. In other embodiments, the brush mechanism can be implemented on a belt driven feeder house.

Advantageously, the conveyor feeder house chain slat in accordance with some embodiments incorporates a stiff brush to pull the crop into the combine. The chain slat having a brush assembly, in accordance with embodiments disclosed herein, is much more forgiving to the crop than current chain slats existing on the market. In particular, the brush assembly does not contain a sharp, hard edge that damages the crop as the current chain slats possess; yet, the brush assembly is still stiff enough to effectively bring in the crop. The conveyor feeder house chain slat in accordance with some embodiments includes a more effective conveyor design to harvest the crop over existing technologies. The conveyor feeder house chain slat in accordance with some embodiments effectively eliminates damage to the crop. That is, no grain or yield loss exists when the conveyor feeder house chain slat having the brushing assembly disclosed herein is implemented with a combine design, as opposed to the damaged grain that typically occurs with existing technologies.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Reference in the description to “one embodiment” or “an embodiment” means that a particular feature, structure, or characteristic described in connection with the embodiment is included in at least one embodiment of the invention. The phrase “in one embodiment” located in various places in this description does not necessarily refer to the same embodiment. Like reference numbers signify like elements throughout the description of the figures.

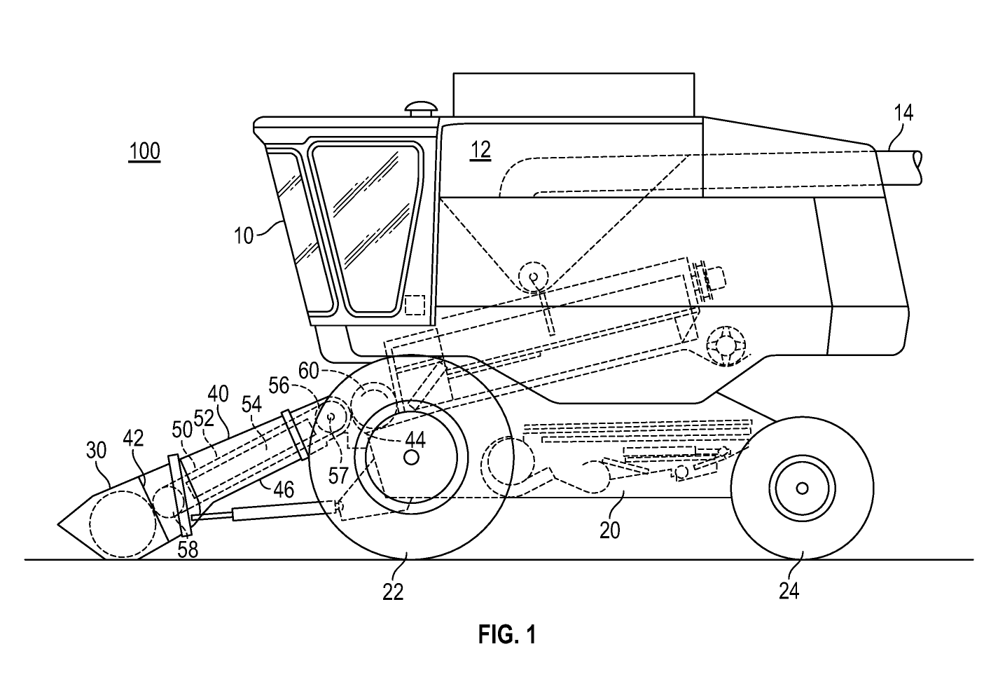

Referring to FIG. 1, a side view of a combine 100 having chain slat with brush assembly, in accordance with some embodiments is illustrated. The combine 100 for harvesting agricultural crops may include a supporting structure 20 having ground-engaging wheels 22, 24 extending from the supporting structure 20. The operation of the combine 100 may be controlled from the operator's cab 10. In the alternative, the combine may be remotely controlled by a controlling mechanism (not shown). The combine 100 may also include a harvesting platform 30 is used for harvesting a crop bearing grain. In particular, when the crop is cut by the harvesting platform 30, it is directed to a crop inlet 42 at the front of a feeder house 40. The feeder house 40 may comprise a conveyor mechanism 50 that directs the crop upwardly and rearwardly through the feeder house 40. The crop may then be directed out of the feeder house 40 through a rear opening 44 to a separator mechanism 60, which threshes the grain from the crop material. In particular, the feeder house 40 has an internal frame 54, which is used to provide support and structure to the feeder house mechanism 40. The feeder house 40 also has an upwardly and rearwardly inclined housing 46. Once the grain has been separated from the crop material, it is fed into a grain tank 12, and is ultimately dispersed from the combine 100 by means of the unloading auger 14 into other transport or storage mechanisms.

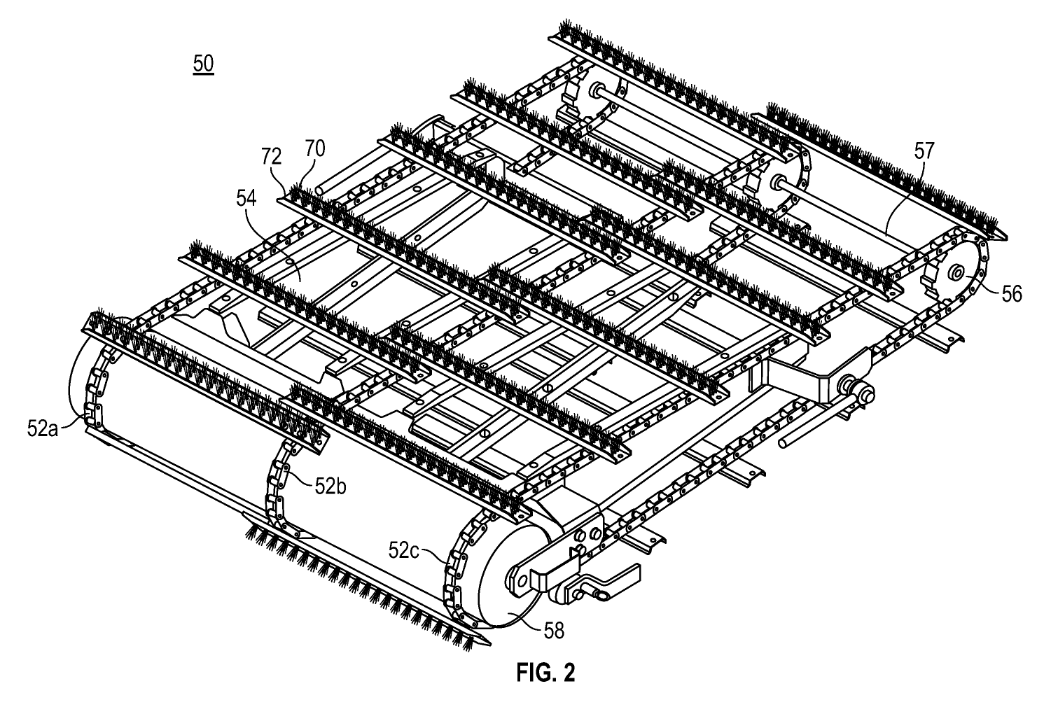

As shown in FIG. 1, the chain-and-slat crop feeding conveyor 50 may include rear drive sprocket means 56 adjacent to the rear portion of the feeder house 40, near the separator mechanism 60, and a transverse drum 58 mounted on a shaft adjacent to the forward end of the feeder house 40. The rear drive sprockets 56 can be mounted on a shaft 57, which is driven from a power source (not shown) within the combine 100. More particularly as shown in FIG. 2, the chain-and-slat crop, feeding conveyor 50 may include conveyor chains 52, which run parallel to each other and are spaced equidistant from each other are entrained around the rear drive sprockets 56 and the front transverse drum 58. The chains 52a, 52b, 52c are continuous chains that move laterally within the feeder house 40, around the transverse drum 58 and the sprockets 56. The number of chains 52 used can correspond with the number of drive sprockets 56 affixed to the shaft 57. In the example shown in FIG. 2, three (3) chains 52a, 52b, 52c are used, although it can be appreciated that the number can vary. A plurality of identical slats 70 may have opposite ends connected to adjacent chains 52, which may be spaced at regular intervals along the lengths of the chains 52. As shown, in some embodiments, one end of each slat 70 may be connected to the center chain 52b, while the outer end of alternating slats 70 can be connected to one of the outer chains 52a and the outer ends of the remaining slats 70 can be attached to the other outer chain 52c, so that the slats 70 are staggered for increased crop processing efficiency.

In some embodiments, a brush mechanism 72 may couple to at least one metal slat 70. In some embodiments, the brush mechanism 72 can be coupled to at least one non-metal slat 70. In some embodiments, the brush mechanism 72 can be implemented on a chain driven feeder house 40. In some embodiments, the brush mechanism 72 can be implemented on a belt driven feeder house 40.

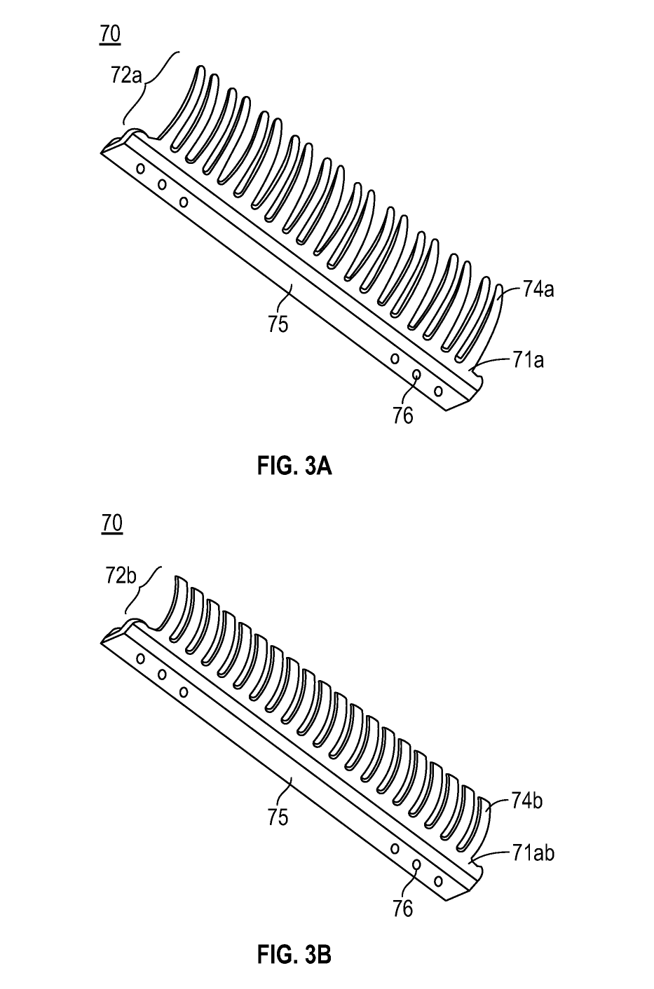

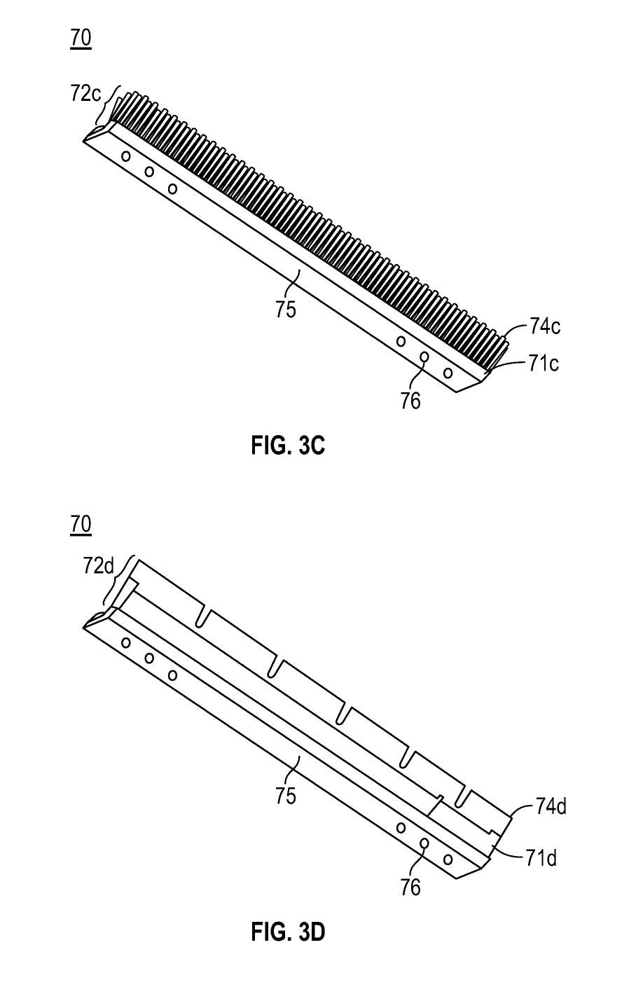

Each chain slat 70 may include a brush assembly 72 that provides sufficient grasp without having a damaging effect upon the crops, wherein the crop throughput is improved while reducing damage to the crop. As can be seen in FIGS. 3A, 3B, and 4, the brush assembly 72 on each slat 70 of the conveyor mechanism 50 may include at least one row of flexible members 74 coupled to a brush base 71. The brush base 71 may couple to the base 75 of the slat 70. The slat base 75 may also include a plurality of through-material holes 76 at the outer ends of the base 75 for fastening the slats 70 to the at least two continuous conveyor chains 52a, 52b, 52c using a fastening means; wherein, the fastening means may include, for example, rivets, solder, nuts, bolts, and the like. As shown, the slats include one or more recess openings 76. In particular as shown in FIG. 3A, elongated curved fingers 74a couple to a brush base 71. The brush assembly 72a may couple to slat base 75 to form chain slat 70. In the alternative referring to FIG. 3B, flat rectangular fingers 74b couple to a brush base 71b. The brush assembly 72b may couple to slat base 75 to form chain slat 70. In some embodiments as shown in FIG. 4, three rows of flexible members 74 may be arranged in tufts and received in stepped openings 78 through the brush base 72b. In some embodiments, the flexible members may include at least one row of straight or curved brush bristles (not shown). Although three rows of flexible members 74 are shown, those skilled in the art could appreciate that the brush assembly 72b may be comprised of one or more rows of flexible members.

Turning to FIGS. 3C and 3D, the brush assembly 72 on each slat 70 of the conveyor mechanism 50 may include at least one row of flexible elongated cylindrical members 74 coupled to a brush base 71. Similar to the previous FIGS. 3A and 3B, the brush base 71 may couple to the base 75 of the slat 70. In the alternative referring to FIG. 3D, a flexible panel 74d having notches 73d couple to a brush base 71d. The brush assembly 72d may couple to slat base 75 to form chain slat 70. In some embodiments, the brush assembly 72c and 72d may comprise rubber, silicon, plastic, and the like. As can be appreciated by those skilled in the art, the flexible members may include one or more rows of bristles, finger, tine, tooth, paddle and the like. These may be composed or constructed of but not limited to metal, alloy, rubber, plastics, composite fabric material and the like. These may be manufactured by either fabrication of two or more individual parts coupled together or by casting or molding of parts from raw material.

In some embodiments, the flexible members 74 may be made of a metal or non-metal material. The slat base 75a may comprise a U-shaped section having open ends, wherein the brush assembly 72 couples to a middle portion of the U-shaped section between the open ends (not shown). Alternatively, the slat base 75 may comprise a L-shaped section (not shown) having a horizontal portion and a vertical lip, wherein the brush assembly 72 couples to the vertical lip of the L-shaped section; and wherein, the horizontal portion having the plurality of recess openings 76 for securing the slats 70 to the at least two continuous conveyor chains 52a, 52b, 52c using the securing means.

In operation, crop material may be provided through the harvesting platform 30 at an inlet 42 of the feeder house 40. Further, the crop material may be gripped between a brush assembly 72 and an interior portion 46 of the feeder house 40, wherein the brush assembly 72 couples to each of the one or more chain slats 70 of the conveyor mechanism 50. For example, at least one row of a plurality of brush bristles 74 on a leading edge of each of the one or more slat may grip the crop material, wherein the brush bristles 74 retrieve the crop from the harvesting platform 30 without damaging the crop. The crop material can be gripped with at least one row of a plurality of curved elongated fingers 74a (FIG. 3A) or a plurality of flat rectangular fingers 74B (FIG. 3B). In addition, the method may include pulling the gripped crop material along the interior wall of the housing 46 and through the feeder house 40. Further, the conveyor mechanism 50 may provide the crop material to a threshing mechanism 60 for separating the grain form the crop material other than grain using the brush mechanism 72. Additionally, the method may include separating the grain from the crop material other than grain, using the separator 60.

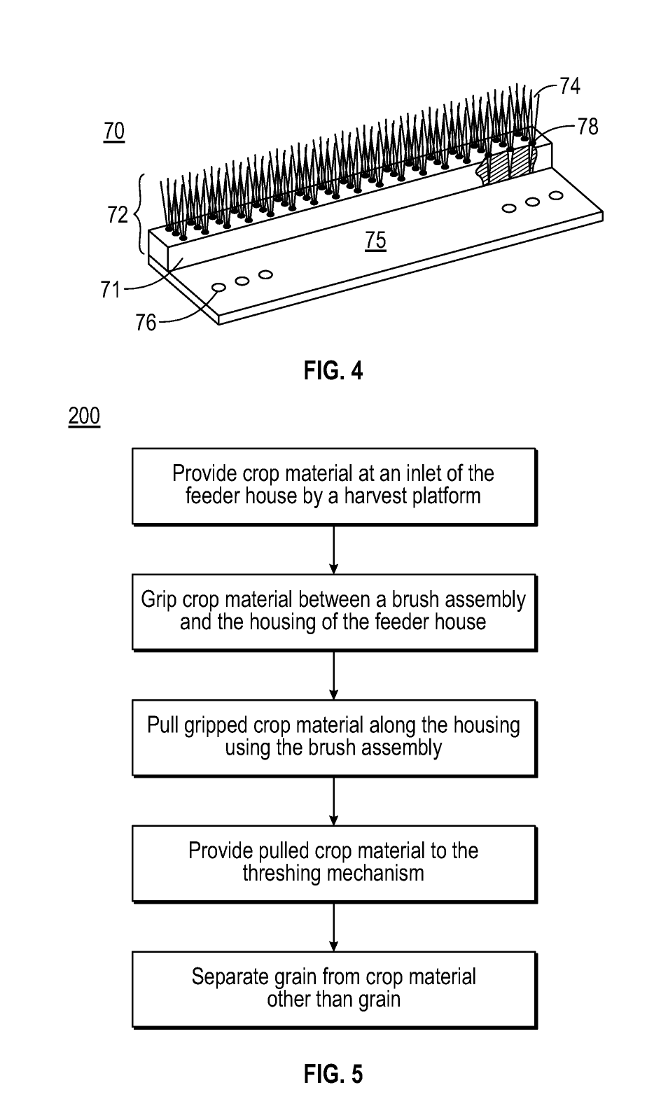

FIG. 5 is an exemplary flow diagram of a method 200 for harvesting grain using the brush assembly, in accordance with some embodiments. In an action 210, the combine may provide crop material at an inlet of the feeder house. For example, after the crop material is cut by the harvesting platform, the crop material is provided at the inlet of the feeder house. In an action 220, the conveyor mechanism may grip the crop material between a brush assembly and a portion of the housing for the feeder house (for example, any portion of the interior wall of the housing form the feeder house, such as the top or bottom floor of the feeder house), wherein the brush assembly couples to each of the one or more chain slats of the conveyor mechanism. For example, the gripping action 220 may include gripping the crop material with at least one row of a plurality of brush bristles on a leading edge of each of the one or more slat, wherein the curved brush bristles for retrieving the crop from the harvesting platform without damaging the crop. The crop material may be gripped with at least one row of a plurality of curved elongated fingers, or at least one row of a plurality of flat rectangular fingers that curve to retrieve the crop from the harvesting platform. Further in an action 230, the method may include pulling the gripped crop material along the housing portion (for example, the side interior walls, top or bottom floor of the feeder house) and through the feeder house using the brush assembly. Additionally, in an action 240, the method can include providing the crop material to a threshing mechanism for separating the grain form the crop material other than grain using the brush mechanism. Further, the method may include separating the grain from the crop material other than grain, in an action 250.

In the above description, numerous details are set forth. It will be apparent, however, to one skilled in the art, that the present invention may be practiced without these specific details. It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled. Although detailed illustrative embodiments are disclosed herein, specific functional details disclosed herein are merely representative for purposes of describing embodiments. Embodiments may, however, be embodied in many alternate forms and should not be construed as limited to only the embodiments set forth herein.

It should be understood that although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “I” symbol includes any and all combinations of one or more of the associated listed items. As used herein, the singular forms “a”, “an” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

What is claimed is:

1. In a combine for harvesting a crop bearing grain, a mechanism for conveying grain from a harvesting platform to a separator mechanism, the conveying mechanism comprising:
a feeder house having a forward crop inlet for receiving crop from the harvesting platform and a rear opening for transmitting crop to the separator mechanism;
and a conveyor comprising
a transverse drum at a front end of the feeder house;
at least two sprocket drive means at a rear end of the feeder house;
at least two continuous conveyor chains being entrained around the sprocket drive means and the transverse drum so as to move laterally in the feeder house, around the transverse drum and the sprocket-driven means; and
a plurality of slats secured to the continuous conveyor chains, at least one slat having a brush assembly for retrieving the crop from the harvesting platform without damaging the crop.

2. The conveying mechanism of claim 1, wherein the slat comprises:
a slat base having a forward end and a rearward end;
wherein the brush assembly coupled to the forward end of the slat base;
wherein the slat base having a plurality of through-material holes at outer ends of the slat base for securing the slats to the at least two continuous conveyor chains using a securing means.

3. The conveying mechanism of claim 1, wherein the brush assembly comprises:
a brush base; and
at least one row of flexible members coupled to the brush base.

4. The conveying mechanism of claim 3, wherein the at least one row of flexible members comprises:
a plurality of brush bristles arranged in tufts and received in stepped openings through the brush base.

5. The conveying mechanism of claim 3, wherein the at least one row of flexible members comprises:
at least one row of curved elongated fingers, curved to hook the crop without damaging the crop.

6. The conveying mechanism of claim 3, wherein the at least one row of flexible members comprise:
at least one row of flat rectangular fingers, wherein each flat rectangular finger is curved to hook the crop without damaging the crop.

7. A slat for a chain and slat conveyor for a feeder house in a harvesting machine such as a combine, the slat comprising:
a slat base; and
a brush assembly coupled to the slat base, the brush assembly having at least one row of flexible members for retrieving the crop from the harvesting platform without damaging the crop;
wherein the slat base having a plurality of through-material holes at the outer ends of the base for fastening the slats to the at least two continuous conveyor chains using a fastening means.

8. The slat of claim 7, wherein the brush assembly comprises:
a brush base; and
at least one row of flexible members coupled to the brush base.

9. The slat of claim 8, wherein the at least one row of flexible members comprises:
a plurality of brush bristles arranged in tufts and received in stepped openings through the brush base.

10. The slat of claim 8, wherein the at least one row of flexible members comprises:
at least one row of curved elongated fingers, curved to hook the crop without damaging the crop.

11. The slat of claim 8, wherein the at least one row of flexible members comprises:
at least one row of flat rectangular fingers, wherein each flat rectangular finger is curved to hook the crop without damaging the crop.

12. The slat of claim 7, wherein the slat base comprises:
a U-shaped section having open ends, wherein the brush assembly couples to a middle portion of the U-shaped section between the open ends.

13. The slat of claim 7, wherein the slat base comprises:
a L-shaped section having a horizontal portion and a vertical lip, wherein the brush assembly couples to the vertical lip of the L-shaped section and wherein the horizontal portion having the plurality of through-material holes for fastening the slats to the at least two continuous conveyor chains using the fastening means.

14. The slat of claim 7, wherein the slat base comprises:
a forward end and a rearward end, wherein the brush assembly coupled to the forward end of the slat base.

15. A method of processing of crop material through a combine feeder house having a transverse mounted drum mounted on a shaft at a front thereof and one or more drive sprockets at a rear thereof with one or more chains positioned around and rotating around the transverse mounted drum and one or more drive sprockets, with one or more chain slats positioned parallel to the transverse drum, the method comprising:
providing crop material at an inlet of the feeder house;
gripping the crop material between a brush assembly and a housing portion of the feeder house, wherein the brush assembly couples to each of the one or more chain slats; and
pulling the gripped crop material along the housing portion and through the feeder house.

16. The method of claim 15, wherein the gripping of the crop material comprises:
gripping the crop material with at least one row of a plurality of brush bristles on a leading edge of each of the one or more slat, wherein the plurality of brush bristles retrieve the crop from the harvesting platform without damaging the crop.

17. The method of claim 15, wherein the gripping of the crop material comprises:
gripping the crop material with at least one row of a plurality of curved elongated fingers on a leading edge of the one or more slat, wherein the curved elongated fingers retrieve the crop from the harvesting platform without damaging the crop.

18. The method of claim 15, wherein the gripping of the crop material comprises:
gripping the crop material with at least one row of a plurality of flat rectangular fingers on a leading edge of the one or more slat, wherein the flat rectangular fingers are curved retrieve the crop from the harvesting platform without damaging the crop.

19. The method of claim 15, further comprising:
providing the crop material to a threshing mechanism for separating the grain form the crop material other than grain using the brush mechanism.

20. The method of claim 19, further comprising:
separating the grain from the crop material other than grain.
providing crop material at an inlet of the feeder house;
gripping the crop material between a brush assembly and a housing portion of the feeder house, wherein the brush assembly couples to each of the one or more chain slats; and
pulling the gripped crop material along the housing portion and through the feeder house.

16. The method of claim 15, wherein the gripping of the crop material comprises:
gripping the crop material with at least one row of a plurality of brush bristles on a leading edge of each of the one or more slat, wherein the plurality of brush bristles retrieve the crop from the harvesting platform without damaging the crop.

17. The method of claim 15, wherein the gripping of the crop material comprises:
gripping the crop material with at least one row of a plurality of curved elongated fingers on a leading edge of the one or more slat, wherein the curved elongated fingers retrieve the crop from the harvesting platform without damaging the crop.

18. The method of claim 15, wherein the gripping of the crop material comprises:
gripping the crop material with at least one row of a plurality of flat rectangular fingers on a leading edge of the one or more slat, wherein the flat rectangular fingers are curved retrieve the crop from the harvesting platform without damaging the crop.

19. The method of claim 15, further comprising:
providing the crop material to a threshing mechanism for separating the grain form the crop material other than grain using the brush mechanism.

20. The method of claim 19, further comprising:
separating the grain from the crop material other than grain.
